(19) United States
(12) Patent Application Publication
(10) Pub. No.: US 2011/0040828 A1
(43) Pub. Date: Feb. 17, 2011

(54) Method and System for Authoring Mobile Content in a Slideshow or Presentation Application for Direct Delivery to a Mobile Device

(75) Inventors: Michael Leblanc, Fredericton (CA); Jody D. Glidden, Sterling, VA (US)

Correspondence Address: RIM, 1000 LOUISIANA STREET, FIFTY-THIRD FLOOR, HOUSTON, TX, 77002, US

(73) Assignee: CHALK MEDIA SERVICE CORP., Vancouver, BC (CA)

(21) Appl. No.: 12/809,378

(22) PCT Filed: Dec. 22, 2008
(86) PCT No.: PCT/CA08/02275

§ 371 Date: Nov. 1, 2010

Related U.S. Application Data
(60) Provisional application No. 61/008,905, filed on Dec. 20, 2007.

(51) Int. Cl. G06F 15/16

(52) U.S. Cl. 709/203

(57) ABSTRACT

A solution is provided to current mobile content delivery problems which allows an author to create and automatically deliver slideshow or presentation application content from the slideshow or presentation application to a selected user's mobile device. No end-user intervention to deliver the slideshow or presentation application content is required. The content is automatically saved directly to the end-user's mobile device and is rendered using the mobile device's mobile content player.

### REFERENCE TO RELATED APPLICATIONS

The present application claims the benefits, under 35 U.S.C. §119(e), of U.S. Provisional Application Ser. No. 61/008,905 filed Dec. 20, 2007 entitled “A Method and System for Authoring Mobile Content in PowerPoint™ for Direct Delivery to a Mobile Device” which is incorporated herein by this reference.

### TECHNICAL FIELD

The application relates to the field of delivery of content such as graphics, audio and video to mobile devices.

### BACKGROUND

Mobile content delivery systems for slideshow or presentation applications such as Microsoft® PowerPoint® exist in the market today. Mobile content delivery is when content that is developed specifically for a mobile device is delivered or sent to a selected user's mobile handheld device. The content is developed, packaged, and then sent to a user in a format that allows playback on a mobile device.

The problem today is that current systems do not provide automatic delivery to a user's mobile device. The slideshow or presentation application content is packaged and delivered as an e-mail attachment or is retrieved through an HTML link on a web page. With these methods, the user must download the slideshow or presentation application file as an e-mail attachment or download the slideshow or presentation application file as a link on an HTML page. These methods do not support audio and video that is embedded into the slideshow or presentation application file. These methods do not allow for the tracking of when the slideshow or presentation application content was accessed or if it was successfully delivered to the device. These methods also require end-user interaction and intervention for successful delivery.

The foregoing examples of the related art and limitations related thereto are intended to be illustrative and not exclusive. Other limitations of the related art will become apparent to those of skill in the art upon a reading of the specification and a study of the drawings.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a schematic drawing illustrating the method and system of the application.

FIG. 2 is a flowchart illustrating the method and system of the application.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

In referring herein to a “mobile device”, such mobile device is a two-way communication device with advanced data communication capabilities including the capability to communicate with other mobile devices or computer systems through a network of transceiver stations. The mobile device may also have the capability to allow voice communication. Depending on the functionality provided by the mobile device, it may be referred to as a data messaging device, a two-way pager, a cellular telephone with data messaging capabilities, a wireless Internet appliance, or a data communication device (with or without telephony capabilities).

This application works in conjunction with an application described in pending international patent application no. PCT/CA2008/000851 published Nov. 13, 2008 entitled, “Method and System for Pushing Content to Mobile Devices” which is incorporated herein by reference.

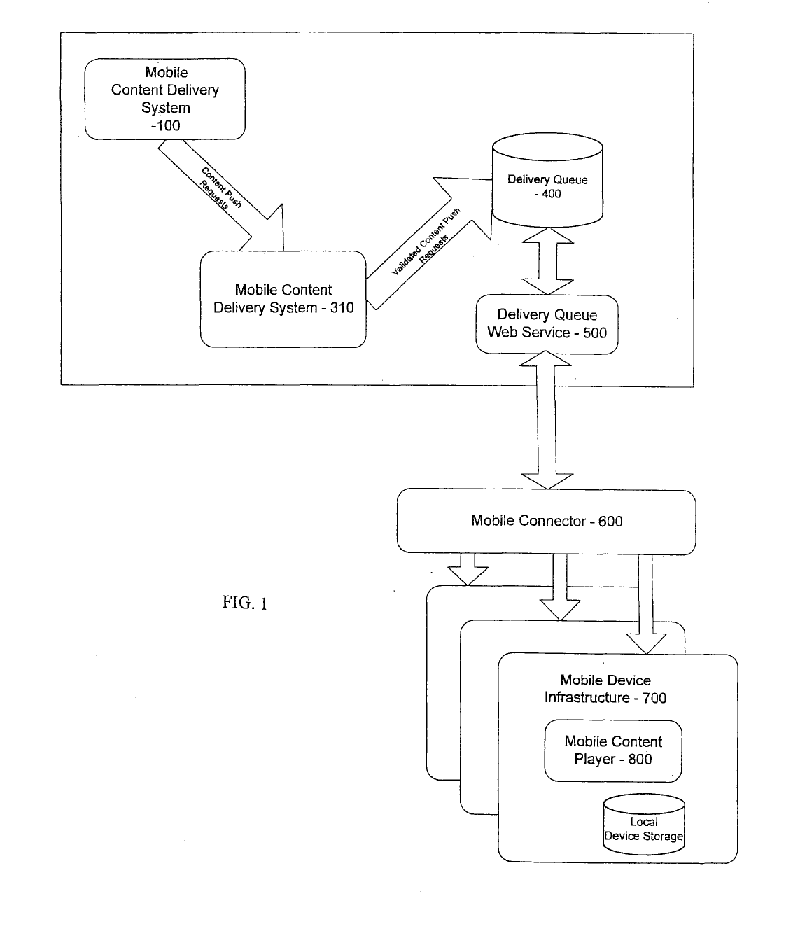

As shown in FIG. 1, this application is comprised of a number of components that work together to allow a user to create and automatically deliver the slideshow or presentation application content from the slideshow or presentation application to a selected user's mobile device. These are described in the following sections.

The current implementation of this application is an add-in application integrated within the slideshow or presentation application. When it is installed, a separate menu item appears in the slideshow or presentation application menu that provides the user with options for authoring, publishing, and delivering the content. With this application, the user can open an existing content file or create a new content file and insert the desired compatible media formats. The content and all inserted media is packaged directly in the slideshow or presentation application in a format supported for a mobile device, sent to the MCDS, and then delivered to the user's mobile device. Other implementations of this application would include a standalone version where the content source files are supplied as input to the application. Alternatively it could also be implemented as a Web Application accessible entirely from inside a web browser. Combinations of the aforementioned applications are also possible.

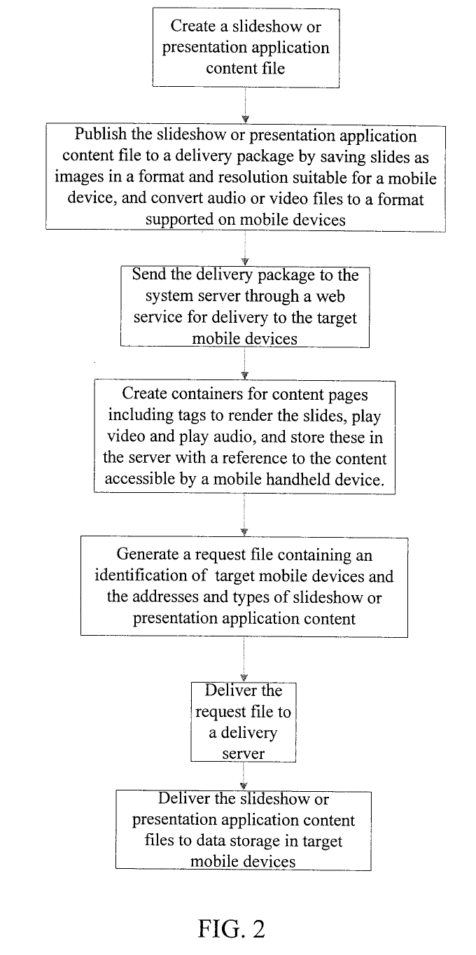

This application provides an easy method for users to create, publish, and deliver content. The features in this application allow the user to insert a pre-recorded audio file, a pre-recorded video file, or to record a video in the authoring tool to be inserted into the content. It allows the user to set content tracking options, schedule immediate content delivery or enter a preferred content delivery date, and select users or groups with mobile devices for the delivery of the content. The application also allows the user to view reports to see the status of the assigned content for the selected users or groups. The method is illustrated in FIG. 2 and described as follows.

Authoring Process

With this application, the author opens an existing presentation or creates a new presentation in the slideshow or presentation application. The author adds content to the slideshow or presentation application slides and then from the application menu, inserts audio and video as desired within the slides. Alternatively the author can use the slideshow or presentation application to add the video and audio. When the user has completed authoring the content, the user selects to publish the content from a publish feature within the application menu. The user then chooses the desired publish and delivery options for the content. When the options are set, the user publishes and delivers the content directly to the user's mobile device simply by pushing a button within the publish feature interface.

Automatic Delivery Process

When the publish and delivery feature is triggered within the slideshow or presentation application add-in, the application packages the content and sends the package to the MCDS where it is further processed for compatibility to play on a mobile device. This processing and packaging can all be performed on the author's computer or the server application (MCDS in the current implementation) or both. After the final packaging is complete, the content is delivered to the user's mobile device using the methods described in pending international patent application no. PCT/CA2008/000851 published Nov. 13, 2008 entitled, “Method and System for Pushing Content to Mobile Devices”. The content is also rendered on the mobile device using methods described in the aforementioned patent application.

There are a number of components that work together for this application to function properly that are described in the following sections.

Mobile Content Delivery System—100

The mobile content delivery system allows users to create, publish, and deliver content directly from within the slideshow or presentation application to selected users or groups. Other mobile content delivery systems for slideshow or presentation applications exist in the market today. With these existing systems, the content is packaged and delivered as an e-mail attachment or is retrieved through an HTML link on a Web page. With these methods, the content is not delivered directly to the user's mobile device. These methods do not support audio and video that is embedded into the slideshow or presentation application file. These methods do not allow for the tracking of when the slideshow or presentation application content was accessed or if it was successfully delivered to the device. These methods also require interaction and intervention from the end-user for successful delivery.

With this application, the content is created and then converted to a mobile content format that is processed through various methods for automatic delivery to a user's mobile device. When the author chooses to publish content to the MCDS, the following happens in the current implementation:
The slides are saved as images in PNG format that are resampled to a resolution compatible for a mobile device.
Any audio that was inserted into the slides as MP3 files or WAV files are automatically transcoded to an AMR Audio format that is a format supported on mobile handheld devices used for the implementation of this application.
The graphic slides, AMR audio files, and any embedded videos are packaged into a ZIP file then sent to the MCDS server through a web service.
Video is converted to a format playable on a mobile handheld device as it is inserted into the slideshow or presentation. The current implementation uses an MPEG-4 3GP video output. Alternatively the video could be converted to a format playable on the mobile handheld device after the author has finished inserting all video. This would occur as soon as the author selected publish. In this case all pre-inserted videos would be transcoded before packaging and sending them to the server application.

Other implementations would include saving slides in other formats other than PNG. This would include any graphics file format such as TIFF, JPEG, GIF, BMP, etc. As well the audio and video output format could be in other formats depending on what the target mobile handheld device is capable of rendering. The current implementation does all conversions and preliminary content packaging on the authoring computer. This could also be performed on the server application in which case the authoring computer would be used to package all input then send to the server application. The current implementation used the authoring computer to do the media conversions because of the processing time required to do the conversions. This is a distributed content transcoding implementation where the processing power of authoring computers are used to do media conversions. The alternative is to implement a centralized content transcoding service where the server would do all transcodings. A combination of the two is also possible. This could be determined at runtime based on current server load (e.g. if the server is too busy to do media transcoding then perform it on the authoring computer.)

The MCDS 100 receives the content package that was generated in the slideshow or presentation application add-in through a Web Service call with the publishing and delivery instructions. The MCDS 100 then processes the content package by creating containers for the content pages, preferably in the form of HTML pages for each slide and placing the proper tags in for the audio and video assets that were added using the slideshow or presentation application add-in. At this point, the content package is ready to be sent to the mobile device. While HTML pages are preferred, other types of mark-up languages may also be used such as HDML, XML, CHTML, WML, XHTML or others.

The request to send the content package to the mobile device is then sent to the Mobile Content Delivery System—310 to deliver the content directly to the user's mobile device. This request contains information on what type the content is (for example a Mobile Learning Course) and target user information so the delivery can be directed to individual users. It also contains information the delivering system requires to find all elements of the content to be delivered. The content assignment does not require any knowledge of the mobile transport/platform being used. This information is configured in the Mobile Connector System—600 and is tied to a user's device type.

Mobile Content Delivery System—310

This component receives requests for delivering content. These requests come from a system component that is assigning the content to users. The request is verified to be in the proper format then processed. The request is an XML document that describes the content that is being delivered and has the following elements.
Target—This is an identifier for where the content needs to be delivered. It is typically the user's e-mail address. The target is used to look up what type of device the user has and then it establishes the proper transport to be used to do the delivery.
Content Type—Based on this content type the delivery system can intelligently establish the location of all the content to delivered.
Content Location—This consists of one or more URLs to the content being delivered. When combined with the Content Type this component is able to locate all content dependencies that are required to be delivered to the Mobile device.

The current implementation utilizes XML to describe the content. This could be implemented in any number of markup languages or formats.

When this is received, the Mobile Content Delivery System looks up the Target and determines if the user has a mobile device and if that device has a transport defined. This causes the following additional information to be gathered:
Transport Type—This is the Mobile device infrastructure that is used to actually deliver the content.
Transport Details—This consists of transport specific details that will be used to actually deliver the content. Each transport type will have its own details that are used by the Mobile Content Delivery System's implementation of the transport.
Additional Target Info—This may contain additional information required for the transport to successfully deliver the content such as a device ID. Multiple identifiers are possible depending on the transport being used.

If the user does not have a mobile device or a transport has not been defined for it, then the appropriate response is returned. It is a requirement that every user in the content management system register with the Mobile Content Delivery System to ensure the delivery can take place.

When all this information is gathered, the Mobile Content Delivery System places the XML request onto a Queue with a status of “New.” This is the Delivery Queue—400. Each XML request is also populated with a company identifier that determines which company is authorized to view the XML request on the queue.

Delivery Queue Web Service—500

This component listens for requests made by the Mobile Connector—600. These are requests to determine if there are items on the queue that the Mobile Connector is able to extract.

Mobile Connector—600

This component polls the Delivery Queue Web Service in predefined intervals to see if there is any content available that needs to be delivered.

Each Mobile Connector is configured for a specific company. The Mobile Connector issues a Web services call to the Delivery Queue Web Service—500. This request contains user credentials that the Web service authenticates against to determine what queue items the Mobile Connector is authorized to see. If there are no items, the Mobile Connector waits for a predefined time interval and then tries again. If it does find an item on the queue, the Mobile Connector retrieves the queued item as an XML document that describes the content. The preferred method is to process one queued item at a time; however it is possible to process multiple queued items at one time. The XML document is described in Mobile Content Delivery System—310.

When the Mobile Connector receives an XML transaction from the Web service, it looks up the required transport for the device type and performs the delivery on the Mobile Device Infrastructure—700. This delivery involves the Mobile Connector sending the XML document describing the contents (this document can be referred to as a manifest) to the Mobile Device Infrastructure. The Mobile Device Infrastructure will extract each content item's URL from the XML Document (manifest) and retrieve each content item from the Mobile chalkboard Server.

The Mobile Connector returns result codes back to the Delivery Queue Web Service based on its ability to successfully send the delivery request to the Mobile Device Infrastructure.

Mobile Device Infrastructure—700

The Mobile Connector can work simultaneously with several Mobile platforms or transport types. This can be any transport that allows a real-time delivery of content to a mobile device, or any mechanism that puts the content directly onto the mobile devices over the air.

Mobile Content Player—800

The Mobile Content Player is identical to that described in pending international patent application no. PCT/CA2008/000851 published Nov. 13, 2008 entitled, “Method and System for Pushing Content to Mobile Devices” which is incorporated herein by reference.

Once content is delivered to the mobile device it remains in its Local Device Storage for the Mobile Content Player 800 to render it. The delivered content can be removed from either the Mobile Content Player 800 itself or as a command from the Mobile Content Delivery System 310.

The solution can also make use of caching servers for content delivery. When a delivery occurs the content is retrieved from a local caching server instead of the centralized content server.

Applications of This Technology

This application can be used for mobile training courses and for just-in-time corporate communications, such as newsletters, announcements, and advertisements. Also, sales representatives can show prospective clients the benefits of their product with their delivered slideshow or presentation application content package. There are no latency issues with running the content because it is all stored locally on the mobile device. A user can view the content while going in and out of network coverage areas because the content is local to the device.

While the present application has been described for use with Powerpoint, the method can be used in the same way to deliver other files which combine image files with audio and/or video. Additionally, while the application is described as an add-on to Powerpoint, the method could be practised as a standalone application. Also while the application describes the method as occurring over the authoring computer and the server, both functions could be performed on the same computer, in which case only a single packaging step is required.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method of delivering slideshow or presentation application content to one or more of a plurality of mobile devices over a computer network, comprising:
i) creating a slideshow or presentation application content file comprising slides, and optionally audio and/or video;
ii) publishing said slideshow or presentation application content file to a delivery package by saving slides as images in a format and resolution suitable for a mobile device, and converting any audio or video files to a format supported on mobile devices;
iii) sending said delivery package to the system server through a web service for delivery to one or more target mobile devices;
iv) creating a container for content that includes tags to render each slide and play each audio or video file, storing said container in a content database and associating each said container with an address;
v) generating a request file containing an identification of said target mobile devices and the addresses and types of said slideshow or presentation application content;
v) delivering said request file to a delivery server; and
vi) delivering said slideshow or presentation application content files to data storage means in said one or more target mobile devices.

2. The method of claim 1 wherein said format of said slide image file format is PNG.

3. The method of claim 1 wherein said container comprises HTML pages for each slide and tags for each audio or video file.

4. The method of claim 1 wherein said delivery step is done by said delivery server sending the addresses of said content files to the infrastructure for said mobile devices which retrieves said content files from said content database and sends said slideshow or presentation application content files to data storage means in said target mobile devices.

5. The method of claim 1 wherein said delivery step is done by said delivery server receiving said request and retrieving said content files from said content database and sending said selected content files to data storage means in said target mobile devices via the infrastructure for said mobile devices.

6. The method of claim 1 wherein prior to delivering said slideshow or presentation application content files said delivery server determines the transport type of said target mobile devices.

7. The method of claim 1 wherein a delivery queue is formed at said delivery server to communicate with connecting server means communicating with the infrastructure for said mobile devices.

8. The method of claim 1 wherein said request file is an XML file.

9. A computer readable storage medium having program code stored thereon, wherein the program code, when executed by a computer, performs the following tasks:
i) creating a slideshow or presentation application content file comprising slides, and optionally audio and/or video;
ii) publishing said slideshow or presentation application content file to a delivery package by saving slides as images in a format and resolution suitable for a mobile device, and converting any audio or video files to a format supported on mobile devices;
iii) sending said delivery package to the system server through a web service for delivery to one or more target mobile devices;
iv) creating a container for content that includes tags to render each slide and play each audio or video file, storing said container in a content database and associating each said container with an address;
v) generating a request file containing an identification of said target mobile devices and the addresses and types of said slideshow or presentation application content;
v) delivering said request file to a delivery server; and
vi) delivering said slideshow or presentation application content files to data storage means in said one or more target mobile devices.

10. The computer readable storage medium of claim 9 wherein said format of said slide image file format is PNG.

11. The computer readable storage medium of claim 9 wherein said container comprises HTML pages for each slide and tags for each audio or video file.

12. The computer readable storage medium of claim 9 wherein said delivery step is done by said delivery server sending the addresses of said slideshow or presentation application content files to the infrastructure for said mobile devices which retrieves said content files from said content database and sends said selected content files to data storage means in said target mobile devices.

13. The computer readable storage medium of claim 9 wherein said delivery step is done by said delivery server receiving said request and retrieving said content files from said content database and sending said slideshow or presentation application content files to data storage means in said target mobile devices via the infrastructure for said mobile devices.

14. The computer readable storage medium of claim 9 wherein prior to delivering said content files said delivery server determines the transport type of said target mobile devices.

15. The computer readable storage medium of claim 9 wherein a delivery queue is formed at said delivery server to communicate with connecting server means communicating with the infrastructure for said target mobile devices.

16. The computer readable storage medium of claim 9 wherein said request file is an XML file.

17. A system for delivering slideshow or presentation application content to one or more of a plurality of mobile devices over a computer network, comprising:
i) data storage means for storing said slideshow or presentation application content;
ii) computer-implemented means for creating a slideshow or presentation application content file comprising slides, and optionally audio and/or video and publishing said slideshow or presentation application content file to a delivery package by saving in said data storage means slides as images in a format and resolution suitable for a mobile device, and converting any audio or video files to a format supported on mobile devices;
iii) computer-implemented means for sending said delivery package to the system server through a web service for delivery to one or more target mobile devices;
iv) computer-implemented means for creating a container for content that includes tags to render each slide and play each audio or video file, storing said container in a content database and associating each said container with an address;
v) computer-implemented means for generating a request file containing an identification of said target mobile devices and the addresses and types of said slideshow or presentation application content;
vi) computer-implemented means for delivering said request file to a delivery server; and
vii) computer-implemented means for delivering said slideshow or presentation application content files to data storage means in said one or more target mobile devices.

18. The system of claim 17 wherein said request file is an XML file.

19. The system of claim 17 wherein said container comprises HTML pages for each slide and tags for each audio or video file.

20. The system of claim 17 wherein said delivery is done by a pushing server sending the addresses of said content file to the infrastructure for said mobile devices which retrieves said slideshow or presentation application content file from said content database and sends said slideshow or presentation application content file to said local storage means in said mobile device.

21. The system of claim 17 wherein said delivery is done by a pushing server receiving said request and retrieving said slideshow or presentation application content file from said content database and sending said slideshow or presentation application content file to said local storage means in said mobile device via the infrastructure for said mobile device.
